(19) United States
(12) Patent Application Publication
(10) Pub. No.: US 2011/0086887 A1
(43) Pub. Date: Apr. 14, 2011

(54) Oil-Based Suspension Concentrates

(75) Inventors: Ronald Vermeer, Leverkusen (DE); Peter Baur, Schondorf (DE)

(73) Assignee: Bayer CorpScience AG, Monheim (DE)

(21) Appl. No.: 11/912,069

(22) PCT Filed: Apr. 7, 2006
(86) PCT No.: PCT/EP2006/003202

§ 371 Date: Sep. 22, 2010

(30) Foreign Application Priority Data
Apr. 20, 2005 (DE) 10 2005 018 262.3

(51) Int. Cl. A01N 43/40; A01P 7/04

(52) U.S. Cl. 514/341

(57) ABSTRACT

The present invention relates to new, oil-based suspension concentrates of active agrochemicals, to a process for producing these formulations and to their use for applying the active substances comprised.

The present invention relates to new, oil-based suspension concentrates of active agrochemicals, to a process for producing these formulations and to their use for applying the active substances comprised.

Numerous water-free suspension concentrates of active agrochemicals have already been disclosed. For instance WO 03/000053 describes formulations of this type which in addition to active substance and oil comprise alkanol alkoxylates as penetrants.

The biological activity of these known formulations is, however, not always entirely satisfactory.

From US-A 6 165 940, moreover, non-aqueous suspension concentrates are already known in which besides active agrochemical, penetrant and surfactant or surfactant mixture there is an organic solvent, suitable solvents of this type including liquid paraffin or vegetable oil esters. The biological activity and the stability of the spray liquors preparable from these formulations by dilution with water are, however, not always sufficient.

New, oil-based suspension concentrates have now been found which comprise
at least one insecticide from the class of the neonicotinoids,
at least one penetrant from the class of the alcohol ethoxylates of the formula (I)

R—O-(EO)ₘ—R′ (I)
in which
R is branched or unbranched C₈-C₁₅-alkyl,
m is 5, 6, 7, 8, 9, 10, 11, 12, 13, 14 or 15,
R′ is hydrogen or C₁-C₆-alkyl and
E is CH₂—CH₂,
at least one vegetable oil,
at least one nonionic surfactant or dispersant and/or at least one anionic surfactant or dispersant and
optionally one or more additives from the groups of the emulsifiers, foam inhibitors, preservatives, antioxidants, colorants and/or inert fillers.

Additionally it has been found that the oil-based suspension concentrates of the invention can be produced by mixing
at least one insecticide from the neonicotinoids class,
at least one penetrant from the class of the alcohol ethoxylates of the formula (I)

R—O-(EO)ₘ—R′ (I)
in which
R is branched or unbranched C₈-C₁₅-alkyl,
m is 5, 6, 7, 8, 9, 10, 11, 12, 13, 14 or 15,
R′ is hydrogen or C₁-C₆-alkyl and
E is CH₂—CH₂,
at least one vegetable oil,
at least one nonionic surfactant or dispersant and/or at least one anionic surfactant or dispersant and
optionally one or more additives from the groups of the emulsifiers, foam inhibitors, preservatives, antioxidants, colorants and/or inert fillers
   with one another and optionally subsequently grinding the resultant suspension.

Finally it has been found that the oil-based suspension concentrates of the invention are highly suitable for applying the active agrochemicals comprised to plants and/or their habitat.

It is to be considered extremely surprising that the oil-based suspension concentrates of the invention exhibit very good stability despite containing no thickener. Also unexpected is the fact that they display a better biological activity than the existing formulations most similar in composition. Surprisingly, moreover, in terms of their activity, the oil-based suspension concentrates of the invention also surpass similar preparations which besides the other components contain either only penetrant or only vegetable oil. No such synergistic effect was foreseeable from the above-described prior art.

Furthermore it is surprising that the oil-based suspension concentrates of the invention exhibit better biological activity than commercially customary formulations. It is common knowledge that formulations of systemic active substances in which the substance is present in solution are generally more effective than those in which the active substance is dispersed as solid particles, as is the case in the formulations of the invention. The very rapid uptake of systemic active substances with the formulation of the invention results, for example, in an absence of dependency on temperature and atmospheric humidity, and enhances rain resistance.

The oil-based suspension concentrates of the invention are also notable for a series of further advantages. For instance, their production is less complex than the preparation of corresponding formulations in which thickeners are present. A further advantage is that, when the concentrates of the invention are diluted with water, there is neither significant creaming nor disruptive flocculation, which is frequently the case with existing preparations of this kind. Finally, the formulations of the invention promote the biological activity of the active components comprised, so that in comparison to conventional preparations either a higher activity is obtained or less active substance is needed.

Appropriate active substances are insecticides from the class of the neonicotinoids. They are outstandingly suitable for controlling animal pests (in this regard see the cited documents).

Insecticides from the class of the neonicotinoids can be described by formula (II) below

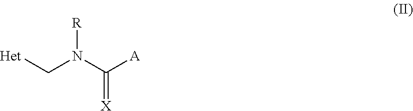

in which
Het is a heterocycle selected from the following group of heterocycles: 2-chloropyrid-5-yl, 2-methylpyrid-5-yl, 1-oxido-3-pyridino, 2-chloro-1-oxido-5-pyridino, 2,3-dichloro-1-oxido-5-pyridino, tetrahydrofuran-3-yl, 5-methyltetrahydrofuran-3-yl, 2-chlorothiazol-5-yl,
A is methyl, N(R¹)(R²) or S(R²),
   in which
   R′ is hydrogen, C₁-C₆-alkyl, phenyl-C₁-C₄-alkyl, C₃-C₆-cycloalkyl, C₂-C₆-alkenyl or C₂-C₆-alkynyl, and
   R² is C₁-C₆-alkyl, C₂-C₆-alkenyl, C₂-C₆-alkynyl, —C(═O)—CH₃ or benzyl,
R is C₁-C₆-alkyl, C₂-C₆-alkenyl, C₂-C₆-alkynyl, —C(═O)—CH₃ or benzyl or together with R² is one of the following groups:
   —CH₂—CH₂—, —CH₂—CH₂—CH₂—, —CH₂—O—CH₂—, —CH₂—S—CH₂—, —CH₂—NH—CH₂—, —CH₂—N—(CH₃)—CH₂— and
X is N—NO₂, N—CN or CH—NO₂
   (see for example EP-A1-192 606, EP-A2-580 533, EP-A2-376 279, EP-A2-235 725).

Mention may be made individually of the following compounds which can be used in accordance with the invention.

One compound used with preference in accordance with the invention is thiamethoxam.

Thiamethoxam has the formula

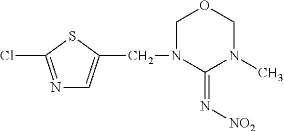

and is known from EP A2 0 580 533.

A further compound used with preference in accordance with the invention is clothianidin.

Clothianidin has the formula

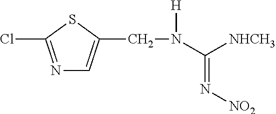

and is known from EP A2 0 376 279.

A further compound used with preference in accordance with the invention is thiacloprid.

Thiacloprid has the formula

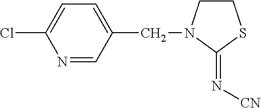

and is known from EP A2 0 235 725.

A further compound used with preference in accordance with the invention is dinotefuran.

Dinotefuran has the formula

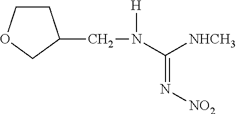

and is known from EP A1 0 649 845.

A further compound used with preference according to the invention is acetamiprid.

Acetamiprid has the formula

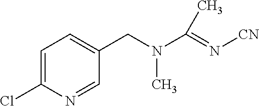

and is known from WO A1 91/04965.

A further compound used with preference according to the invention is nitenpyram.

Nitenpyram has the formula

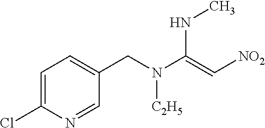

and is known from EP A2 0 302 389.

A further compound used with preference according to the invention is imidacloprid.

Imidacloprid has the formula

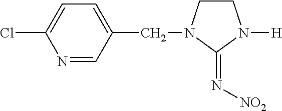

and is known from EP 0 192 060.

Suitable penetrants in the present context are compounds of the formula (I) described earlier on above.

Preferred compounds of the formula (I) are those

in which
R is branched or unbranched C₁₀-C₁₄-alkyl,
m is 6, 7, 8, 9 or 10 and
R′ is hydrogen, methyl, ethyl, n-propyl, isopropyl, n-butyl, isobutyl, t-butyl, n-pentyl or n-hexyl t, in particular hydrogen.

A general definition of the alkanol alkoxylates is given by the above formula (I). These substances are mixtures of substances of the stated type with different chain lengths. The indices therefore have average values which may also deviate from whole numbers.

The alkanol alkoxylates of the formulae indicated are known or can be prepared by known methods (cf. WO 98-35 553, WO 00-35 278 and EP-A 0 681 865).

Suitable vegetable oils include all oils which can normally be used in agrochemical compositions and can be obtained from plants. Examples that may be mentioned include sunflower oil, rapeseed oil, olive oil, castor oil, colza oil, maize seed oil, cottonseed oil and soya-bean oil.

The oil-based suspension concentrates of the invention comprise at least one nonionic surfactant or dispersant and/or at least one anionic surfactant or dispersant.

Suitable nonionic surfactants or dispersants include all substances of this type that can normally be used in agrochemical compositions. Preferably mention may be made of polyethylene oxide-polypropylene oxide block copolymers, polyethylene glycol ethers of linear alcohols, reaction products of fatty acids with ethylene oxide and/or propylene oxide, and also polyvinyl alcohol, polyvinylpyrrolidone, copolymers of polyvinyl alcohol and polyvinylpyrrolidone, and copolymers of (meth)acrylic acid and (meth)acrylic esters, and also alkyl ethoxylates and alkylaryl ethoxylates, which optionally may be phosphated and optionally may be utilized with bases, it being possible for mention to be made, by way of example, of sorbitol ethoxylates, and also polyoxyalkylenamine derivatives.

Suitable anionic surfactants include all substances of this type that can normally be used in agrochemical compositions. Preference is given to alkali metal salts and alkaline earth metal salts of alkylsulphonic acids or alkylarylsulphonic acids.

A further preferred group of anionic surfactants or dispersants includes the following salts that are of low solubility in vegetable oil: salts of polystyrenesulphonic acids, salts of polyvinylsulphonic acids, salts of naphthalenesulphonic acid-formaldehyde condensation products, salts of condensation products of naphthalenesulphonic acid, phenolsulphonic acid and formaldehyde, and salts of ligninsulphonic acid.

Suitable additives which may be included in the formulations of the invention are emulsifiers, foam inhibitors, preservatives, antioxidants, colorants and inert fillers.

Preferred emulsifiers are ethoxylated nonylphenols, reaction products of alkylphenols with ethylene oxide and/or propylene oxide, ethoxylated arylalkylphenols, and also ethoxylated and propoxylated arylalkylphenols, and also sulphated or phosphated arylalkyl ethoxylates and/or arylalkyl ethoxy-propoxylates, it being possible to mention, by way of example, sorbitan derivatives, such as polyethylene oxide-sorbitan fatty acid esters and sorbitan fatty acid esters.

Suitable foam inhibitors include all substances that can normally be used for this purpose in agrochemical compositions. Preference is given to silicone oils and magnesium stearate.

Suitable preservatives include all substances that can normally be used for this purpose in agrochemical compositions of this type. Examples that may be mentioned include Preventol® (Bayer AG) and Proxel®.

Suitable antioxidants include all substances that can normally be used for this purpose in agrochemical compositions. Preference is given to butylated hydroxytoluene.

Suitable colorants include all substances that can normally be used for this purpose in agrochemical compositions. Mention may be made, by way of example, of titanium dioxide, pigmentary carbon black, zinc oxide and blue pigments, and also Permanent Red FGR.

Suitable inert fillers include all substances that can normally be used for this purpose in agrochemical compositions but do not function as thickeners. Preference is given to inorganic particles, such as carbonates, silicates and oxides, and also organic substances, such as urea-formaldehyde condensates. By way of example mention may be made of kaolin, rutile, silicon dioxide, so-called highly disperse silica, silica gels, and also natural and synthetic silicates, and additionally talc.

In one particular embodiment the formulations of the invention may further comprise at least one additional active substance (insecticides, attractants, sterilants, bactericides, acaricides, nematicides, fungicides, growth regulators or herbicides). The insecticides include, for example, phosphates, carbamates, carboxylic esters, chlorinated hydrocarbons, phenylureas, substances produced by microorganisms, etc.

Examples of particularly favourable co-components include the following:

### Fungicides:

### Inhibitors of Nucleic Acid Synthesis

benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid

### Inhibitors of Mitosis and Cell Division

benomyl, carbendazim, diethofencarb, fuberidazole, pencycuron, thiabendazole, thiophanat-methyl, zoxamide

### Inhibitors of Respiratory Chain Complex I

diflumetorim

### Inhibitors of Respiratory Chain Complex II

boscalid, carboxin, fenfuram, flutolanil, furametpyr, mepronil, oxycarboxin, penthiopyrad, thifluzamide

### Inhibitors of Respiratory Chain Complex III

azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin

### Decouplers

dinocap, fluazinam

### Inhibitors of ATP Production

Fentin acetate, fentin chloride, fentin hydroxide, silthiofam

### Inhibitors of Amino Acid Biosynthesis and Protein Biosynthesis

andoprim, blasticidin-S, cyprodinil, kasugamycin, kasugamycin hydrochloride hydrate, mepanipyrim, pyrimethanil

### Inhibitors of Signal Transduction

fenpiclonil, fludioxonil, quinoxyfen

### Inhibitors of Lipid and Membrane Synthesis

chlozolinate, iprodione, procymidone, vinclozolin
ampropylfos, potassium-ampropylfos, edifenphos, iprobenfos (IBP), isoprothiolane, pyrazophos
tolclofos-methyl, biphenyl
iodocarb, propamocarb, propamocarb hydrochloride

### Inhibitors of Ergosterol Biosynthesis

fenhexamid,
azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole, voriconazole, imazalil, imazalil sulphate, oxpoconazole, fenarimol, flurprimidol, nuarimol, pyrifenox, triforine, pefurazoate, prochloraz, triflumizole, viniconazole,
aldimorph, dodemorph, dodemorph acetate, fenpropimorph, tridemorph, fenpropidin, spiroxamine,
naftifine, pyributicarb, terbinafine

### Inhibitors of Cell Wall Synthesis

benthiavalicarb, bialaphos, dimethomorph, flumorph, iprovalicarb, polyoxins, polyoxorim, validamycin A

### Inhibitors of Melanin Biosynthesis

capropamid, diclocymet, fenoxanil, phthalid, pyroquilon, tricyclazole

### Resistance Inductors

acibenzolar-S-methyl, probenazole, tiadinil

### Multisite

captafol, captan, chlorothalonil, copper salts such as: copper hydroxide, copper naphthenate, copper oxychloride, copper sulphate, copper oxide, oxine-copper and Bordeaux mixture, dichlofluanid, dithianon, dodine, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulphur and sulphur preparations containing calcium polysulphide, thiram, tolylfluanid, zineb, ziram

### Unknown Mechanism

amibromdol, benthiazol, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methyl sulphate, diphenylamine, ethaboxam, ferimzone, flumetover, flusulphamide, fluopicolide, fluoroimide, hexachlorobenzene, 8-hydroxy-quinoline sulphate, irumamycin, methasulphocarb, metrafenone, methyl isothiocyanate, mildiomycin, natamycin, nickel dimethyl dithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrol nitrin, quintozene, tecloftalam, tecnazene, triazoxide, trichlamide, zarilamid and 2,3,5,6-tetrachloro-4-(methylsulphonyl)pyridine, N-(4-chloro-2-nitrophenyl)-N-ethyl-4-methylbenzenesulphonamide, 2-amino-4-methyl-N-phenyl-5-thiazolecarboxamide, 2-chloro-N-(2,3-dihydro-1,1,3-trimethyl-1H-inden-4-yl)-3-pyridine-carboxamide, 3-[5-(4-chlorophenyl)-2,3-dimethylisoxazolidin-3-yl]pyridine, cis-1-(4-chloro-phenyl)-2-(1H-1,2,4-triazol-1-yl)cycloheptanol, 2,4-dihydro-5-methoxy-2-methyl-4-[[[[1-[3-(trifluoromethyl)phenyl]ethyliden]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxy-phenyl)imino]methyl]thio]methyl].alpha.-(methoxymethylen)benzacetate, 4-chloro-alpha-propynyloxy-N[2-[3-methoxy-4-(2-propynyloxy)phenyl]ethyl]benzacetamide, (2S)—N-[2-[4-[[3-(4-chlorophenyl)-2-propynyl]oxy]-3-methoxyphenyl]ethyl]-3-methyl-2-[(methylsulphon-yl)amino]butanamide, 5-chloro-7-(4-methylpiperidin-1-yl)-6-(2,4,6-trifluorophenyl)[1,2,4]-triazolo[1,5-a]pyrimidine, 5-chloro-6-(2,4,6-trifluorophenyl)-N-[(1R)-1,2,2-trimethylpropyl]-[1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, N-[1-(5-bromo-3-chloropyridin-2-yl)ethyl]-2,4-dichloronicotinamide, N-(5-bromo-3-chlorpyridin-2-yl)methyl-2,4-dichloro-nicotinamide, 2-butoxy-6-iodo-3-propylbenzopyranon-4-one, N-{(Z)-[(cyclopropylmethoxy)-imino)][6-(difuoromethoxy)-2,3-difluorophenyl]methyl}-2-benzacetamide, N-(3-ethyl-3,5,5-trimethylcyclohexyl)-3-formylamino-2-hydroxybenzamide, 2-[[[[1-[3-(1-fluoro-2-phenyl-ethyl)oxy]phenyl]ethylidene]amino]oxy]methyl]-alpha-(methoxyimino)-N-methyl-alpha-benzacetamide, N-{2-[3-chloro-5-(trifluoromethyl)pyridin-2-yl]ethyl}-2-(trifluoro-methyl)benzamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, 2-(2-{[6-(3-chloro-2-methylphenoxy)-5-fluoropyrimidin-4-yl]oxy}phenyl)-2-(methoxyimino)-N-methyl-acetamide

### Bactericides:

bronopol, dichlorophen, nitrapyrin, nickel dimethyldithiocarbamate, kasugamycin, octhilinone, furancarboxylic acid, oxytetracycline, probenazole, streptomycin, tecloftalam, copper sulphate and other copper preparations.

### Insecticides/Acaricides/Nematicides:

### Acetylcholine Esterase (AChE) Inhibitors

Carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulphan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate
Organophosphates,
for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

### Sodium Channel Modulators/Voltage-Dependent Sodium Channel Blockers

Pyrethroids,
for example acrinathrin, allethrin (d-cis-trans, d-trans), beta-cyfluthrin, bifenthrin, bioallethrin, bioallethrin-S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans-isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrins (pyrethrum)
DDT
Oxadiazines,
for example indoxacarb
Semicarbazone,
for example metaflumizon (BAS3201)

### Acetylcholine Receptor Agonists/Antagonists

Chloronicotinyls,
for example acetamiprid, clothianidin, dinotefuran, imidacloprid, nitenpyram, nithiazine, thiacloprid, thiamethoxam
Nicotine, bensultap, cartap

### Acetylcholine Receptor Modulators

Spinosyns,
for example spinosad

### GABA-Controlled Chloride Channel Antagonists

Organochlorine,
for example camphechlor, chlordane, endosulfan, gamma-HCH, HCH, heptachlor, lindane, methoxychlor
Fiprols,
for example acetoprole, ethiprole, fipronil, pyrafluprole, pyriprole, vaniliprole

### Chloride Channel Activators

Mectins,
for example avermectin, emamectin, emamectin-benzoate, ivermectin, milbemycin

### Juvenile Hormone Mimetics,

for example diofenolan, epofenonane, fenoxycarb, hydroprene, kinoprene, methoprene, pyriproxifen, triprene

### Ecdysone Agonists/Disruptors

Diacylhydrazines,
for example chromafenozide, halofenozide, methoxyfenozide, tebufenozide

### Chitin Biosynthesis Inhibitors

Benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
Buprofezin
Cyromazine

### Oxidative Phosphorylation Inhibitors, ATP Disruptors

Diafenthiuron
Organotin compounds,
for example azocyclotin, cyhexatin, fenbutatin-oxide

### Oxidative Phosphorylation Decouplers Acting by Interrupting the H-Proton Gradient

Pyrroles,
for example chlorfenapyr
Dinitrophenols,
for example binapacyrl, dinobuton, dinocap, DNOC

### Site-I Electron Transport Inhibitors

METI's,
for example fenazaquin, fenpyroximate, pyrimidifen, pyridaben, tebufenpyrad, tolfenpyrad
Hydramethylnon
Dicofol

### Site-II Electron Transport Inhibitors

Rotenone

### Site-III Electron Transport Inhibitors

Acequinocyl, fluacrypyrim

### Microbial Disruptors of the Insect Gut Membrane

Bacillus thuringiensis strains

### Lipid Synthesis Inhibitors

Tetronic acids,
for example spirodiclofen, spiromesifen
Tetramic acids,
for example spirotetramat
Carboxamides,
for example flonicamid
Octopaminergic agonists,
for example amitraz

### Inhibitors of Magnesium-Stimulated ATPase,

Propargite
Nereistoxin analogues,
for example thiocyclam hydrogen oxalate, thiosultap-sodium

### Ryanodine Receptor Agonists,

Benzodicarboxamides,
for example flubendiamide
Anthranilamides,
for example DPX E2Y45 (3-bromo-N-{4-chloro-2-methyl-6-[methylamino)carbonyl]-phenyl}-1-(3-chloropyridin-2-yl)-1H-pyrazole-5-carboxamide)

### Biologicals, Hormones or Pheromones

azadirachtin, Bacillus spec., Beauveria spec., codlemone, Metarrhizium spec., Paecilomyces spec., thuringiensin, Verticillium spec.
   Active Compounds with Unknown or Unspecific Mechanisms of Action
Fumigants,
for example aluminium phosphide, methyl bromide, sulphuryl fluoride
Antifeedants,
for example cryolite, flonicamid, pymetrozine
Mite growth inhibitors,
for example clofentezine, etoxazole, hexythiazox
amidoflumet, benclothiaz, benzoximate, bifenazate, bromopropylate, buprofezin, quinomethionate, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

The amount of the individual components can be varied within a relatively wide range in the oil-based suspension concentrates of the invention. Thus the concentrations
of active agrochemicals are generally between 5% and 40%, preferably between 10% and 37.5%, more preferably between 15% and 35%, very preferably between 20% and 35% by weight,
of penetrant are generally between 5% and 55%, preferably between 15% and 40%, more preferably between 15% and 30% by weight,
of vegetable oil are generally between 15% and 55%, preferably between 20% and 50%, more preferably between 25% and 40% by weight,
of surfactants and/or dispersants are generally between 2.5% and 30%, preferably between 5.0% and 25%, and more preferably between 5% and 15% by weight, and
of additives are generally between 0 and 25%, preferably between 0 and 20% by weight.

The oil-based suspension concentrates of the invention are produced by mixing the components with one another in the respectively desired proportions. The order in which the constituents are combined with one another is arbitrary. Appropriately the solid components are used in a finely ground state. It is, however, also possible to subject the suspension which results after the constituents have been combined first to a coarse grinding and then to a fine grinding, so that the mean particle size is below 20 μm. Preferred suspension concentrates are those in which the solid particles have a mean size between 1 and 10 μm.

The temperatures when carrying out the process of the invention can be varied within a certain range. The work is carried out generally at temperatures between 10° C. and 60° C., preferably between 15° C. and 40° C.

Equipment suitable for carrying out the process of the invention includes customary mixing and grinding apparatus which is used for producing agrochemical formulations.

The oil-based suspension concentrates of the invention constitute formulations which remain stable even following prolonged storage at elevated temperatures or in the cold, since no crystal growth is observed. By dilution with water they can be converted into homogeneous spray liquids. These spray liquids are applied by customary methods, i.e., for example, by spraying, pouring or injecting.

The application rate of the oil-based suspension concentrates of the invention can be varied within a relatively wide range. It is guided by the particular active agrochemicals and by their amount in the formulations.

With the aid of the oil-based suspension concentrates of the invention it is possible to deliver active agrochemicals to plants and/or their habitat in a particularly advantageous way.

With the formulations of the invention it is possible to treat all plants and plant parts. By plants here are meant all plants and plant populations, such as desirable and unwanted wild plants or crop plants (including naturally occurring crop plants). Crop plants may be plants which can be obtained by conventional breeding and optimization methods or by biotechnological and gene-technological methods or combinations of these methods, including the transgenic plants and including the plant cultivars which can or cannot be protected by varietal property rights. By plant parts are to be meant all above-ground and below-ground parts and organs of the plants, such as shoot, leaf, flower and root, an exemplary listing embracing leaves, needles, stems, trunks, flowers, fruit bodies, fruits and seeds and also roots, tubers and rhizomes. The plant parts also include harvested material and also vegetative and generative propagation material, examples being seedlings, tubers, rhizomes, cuttings and seeds.

What may be emphasized in this context is the particularly advantageous effect of the compositions according to the invention with regard to their use in cereal plants such as, for example, wheat, oats, barley, spelt, triticale and rye, but also in maize, sorghum and millet, rice, sugar cane, soya beans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, kumquats, tangerines and satsumas, nuts such as, for example, pistachios, almonds, walnuts and pecan nuts, tropical fruits such as, for example, mango, paw-paw, pineapple, dates and bananas, and grapes) and vegetables (comprising leaf vegetables such as, for example, endives, corn salad, Florence fennel, lettuce, cos lettuce, Swiss chard, spinach and chicory for salad use, cabbages such as, for example, cauliflower, broccoli, Chinese leaves, Brassica oleracea (L.) convar. acephala var. sabellica L. (curly kale, feathered cabbage), kohlrabi, Brussels sprouts, red cabbage, white cabbage and Savoy cabbage, fruit vegetables such as, for example, aubergines, cucumbers, capsicums, table pumpkins, tomatoes, courgettes and sweetcorn, root vegetables such as, for example celeriac, wild turnips, carrots, including yellow cultivars, Raphanus sativus var. niger and var. radicula, beetroot, scorzonera and celery, legumes such as, for example, peas and beans, and vegetables from the Allium family such as, for example, leeks and onions).

The treatment of the plants and plant parts in accordance with the invention with the suspension concentrates is carried out directly or by action on their environment, habitat or storage area in accordance with the customary treatment methods, for example by dipping, spraying, vaporizing, atomizing, broadcasting or painting on and, in the case of propagation material, especially seeds, additionally by single or multiple coating.

The active agrochemicals comprised develop a better biological activity than when applied in the form of the corresponding conventional formulations.

The invention is illustrated by the following examples.

### PREPARATION EXAMPLES

### Example 1

To prepare a suspension concentrate

183 g of imidacloprid
100 g of polyoxyethylene-sorbitol oleate
25 g of singly branched alcohol ethoxylate (20 EO)
42 g of a mixture of alkylarylsulphonate and ethylhexanol
20 g of lignin sulphonate
0.5 g of polydimethylsiloxane
2 g of butylated hydroxytoluene
are introduced with stirring at room temperature into a mixture of
200.0 g of alkanol alkoxylate of the formula

R—O-(EO)₆—H
in which
R is alkyl having 12 to 14 carbon atoms,
EO is —CH₂—CH₂—O,
and
the number 6 represents an average value, and
   427.5 g of sunflower oil.

After the end of the addition the mixture is stirred at room temperature for a further 10 minutes. The resultant homogeneous suspension is subjected first to coarse grinding and then to fine grinding, giving a suspension in which 90% of the solid particles have a size below 6 μm.

### Example 2

To prepare a suspension concentrate

196 g of imidacloprid
100 g of polyoxyethylene-sorbitol oleate
50 g of polyoxyalkyleneamine derivative
50 g of lignin sulphonate
1 g of silicone material
2 g of butylated hydroxytoluene
are introduced with stirring at room temperature into a mixture of
200.0 g of alkanol alkoxylate of the formula

R—O-(EO)₆—H
in which
R is alkyl having 12 to 14 carbon atoms,
EO is —CH₂—CH₂—O,
and
the number 6 represents an average value, and
   401 g of sunflower oil.

After the end of the addition the mixture is stirred at room temperature for a further 10 minutes. The resultant homogeneous suspension is subjected first to coarse grinding and then to fine grinding, giving a suspension in which 90% of the solid particles have a size below 6 μm.

### Example 3

To prepare a suspension concentrate

196 g of imidacloprid
100 g of polyoxyethylene-sorbitol oleate
50 g of polyoxyalkylene-fatty acid glyceride
50 g of lignin sulphonate
0.5 g of polydimethylsiloxane
2 g of butylated hydroxytoluene
are introduced with stirring at room temperature into a mixture of
200.0 g of alkanol alkoxylate of the formula

R—O-(EO)₆—H
in which
R is alkyl having 12 to 14 carbon atoms,
EO is —CH₂—CH₂—O,
and
the number 6 represents an average value, and
   401.5 g of sunflower oil.

After the end of the addition the mixture is stirred at room temperature for a further 10 minutes. The resultant homogeneous suspension is subjected first to coarse grinding and then to fine grinding, giving a suspension in which 90% of the solid particles have a size below 6 μm.

### Example 4

To prepare a suspension concentrate

320 g of imidacloprid
100 g of polyoxyethylene-sorbitol oleate
50 g of polyoxyalkyleneamine derivative
10 g of lignin sulphonate
0.5 g of polydimethylsiloxane
2 g of butylated hydroxytoluene
are introduced with stirring at room temperature into a mixture of
200.0 g of alkanol alkoxylate of the formula

R—O-(EO)₆—H
in which
R is alkyl having 12 to 14 carbon atoms,
EO is —CH₂—CH₂—O,
and
the number 6 represents an average value, and
   317.5 g of sunflower oil.

After the end of the addition the mixture is stirred at room temperature for a further 10 minutes. The resultant homogeneous suspension is subjected first to coarse grinding and then to fine grinding, giving a suspension in which 90% of the solid particles have a size below 6 μm.

### Example 5

To prepare a suspension concentrate

225 g of imidacloprid
100 g of polyoxyethylene-sorbitol oleate
50 g of polyoxyalkyleneamine derivative
10 g of lignin sulphonate
0.5 g of polydimethylsiloxane
2 g of butylated hydroxytoluene
are introduced with stirring at room temperature into a mixture of
200.0 g of alkanol alkoxylate of the formula

R—O-(EO)₆—H
in which
R is alkyl having 12 to 14 carbon atoms,
EO is —CH₂—CH₂—O,
and
the number 6 represents an average value, and
   402.5 g of sunflower oil.

After the end of the addition the mixture is stirred at room temperature for a further 10 minutes. The resultant homogeneous suspension is subjected first to coarse grinding and then to fine grinding, giving a suspension in which 90% of the solid particles have a size below 6 μm.

### Example 6

To prepare a suspension concentrate

196 g of imidacloprid
100 g of polyoxyethylene-sorbitol oleate
50 g of polyoxyalkyleneamine derivative
10 g of lignin sulphonate
0.5 g of polydimethylsiloxane
2 g of butylated hydroxytoluene
are introduced with stirring at room temperature into a mixture of
200.0 g of alkanol alkoxylate of the formula

R—O-(EO)₆—H
in which
R is alkyl having 12 to 14 carbon atoms,
EO is —CH₂—CH₂—O,
and
the number 6 represents an average value, and
   431.5 g of sunflower oil.

After the end of the addition the mixture is stirred at room temperature for a further 10 minutes. The resultant homogeneous suspension is subjected first to coarse grinding and then to fine grinding, giving a suspension in which 90% of the solid particles have a size below 6 μm.

The products used in the examples were as follows:

| | |
|---|---|
| Antifoam 1500: | silicone material |
| Arlaton T(V): | polyoxyethylene-sorbitol oleate |
| Atlas G 1281: | polyoxyalkylene-fatty acid glyceride |
| Atlox MBA 13/20: | singly branched alcohol ethoxylate (20 EO) |
| Atlox 4838 B: | mixture of alkylarylsulphonate and ethylhexanol |
| Borresperse NA: | lignin sulphonate |
| Lutensol TO 6: | alkanol alkoxylate of formula R—O-(EO)₆-H |
| Silfoam 1132: | polydimethylsiloxane |
| Vulkanox BHT: | butylated hydroxytoluene |
| Zephrym PD 7000: | polyoxyalkyleneamine derivative |

### Use Example I

### Penetration Test

This test measures the penetration of active substances through enzymatically isolated cuticles of apple leaves.

The leaves used were cut in the fully developed state from apple trees of the Golden Delicious variety. The cuticles were isolated as follows:
first of all, leaf discs labelled on the underside with dye and formed by punching were filled by means of vacuum infiltration with a pectinase solution (0.2% to 2% strength) buffered to a pH of between 3 and 4,
then sodium azide was added and
the leaf discs thus treated were left to stand until the original leaf structure broke down and the non-cellular cuticle underwent detachment.

Thereafter only those cuticles from the top leaf sides that were free from stomata and hairs were used. They were washed a number of times in alternation with water and with a buffer solution, pH 7. The clean cuticles obtained were, finally, applied to Teflon plaques and smoothed and dried with a gentle jet of air.

In the next step the cuticular membranes obtained in this way were placed in stainless steel diffusion cells (transport chambers) for the purpose of membrane transport investigations. For these investigations the cuticles were placed centrally using tweezers on the edges of the diffusion cells, which were coated with silicone grease, and sealed with a ring, which was likewise greased. The arrangement was chosen so that the morphological outer face of the cuticles was directed outwards, in other words to the air, while the original inner side was facing the interior of the diffusion cell.

The diffusion cells were filled with a 1% phospholipid suspension. Penetration was determined by applying 10 μl of the spray liquor of the composition below, containing radiolabelled imidacloprid, to the outer face of each cuticle. The spray liquor is prepared using local mains water of average hardness.

After the spray liquors have been applied the water was evaporated and then the chambers were inverted and placed in thermostatted troughs, in which the temperature and air humidity over the cuticle was adjustable by means of a gentle air stream onto the cuticles with the spray covering (20° C., 60% rh). At regular intervals, an autosampler took aliquots which were subjected to measurement in a scintillation counter.

The results of the experiments are apparent from the table below. The figures reported are average values from 6 to 8 measurements.

| Formulation/ | Plant and | Imidacloprid | % penetration | % penetration |
|---|---|---|---|---|
| treatment | temperature | conc. (g/l) | after 4-5 h | after 1 day |
| Confidor SL 200 | apple (20° C.) | 0.1 | 0.5 | 2.1 |
| As Example 2 | apple (20° C.) | 0.1 | 20.5 | 41.8 |
| Imidacloprid + | apple (20° C.) | 0.2 | 12.5 | 22.3 |
| Atplus S10¹⁾ | | | | |
| (0.5 g/l) | | | | |
| Imidacloprid + | apple (20° C.) | 0.2 | 6.4 | 27.7 |
| Atplus UCL 1007¹⁾ | | | | |
| (0.5 g/l) | | | | |
| Imidacloprid | apple (20° C.) | 0.1 | 20.6 | 26.5 |
| alcohol ethoxylate | | | | |
| as Example 1 | | | | |
| (0.5 g/l) | | | | |

¹⁾Clathrate of alcohol ethoxylates and urea

### Use Example II

Further experiments were carried out with whole plants. In this case two times 3 μl of spray liquors with Confidor SL200 (comparative) and OD200 (as Example 2) were applied to leaves of the plants described in the table. Following evaporation, the plants were incubated in climate-controlled boxes (day: 20° C., 60% relative humidity, light intensity PAR 200 μE/m 2 s⁻¹; night: 15° C., 80%) and after 3-4 days the amount not taken up was determined by washing of the leaf surface and stripping with cellulose acetate (Silcox and Holloway, 1986). The table below shows the average values from 3-4 repetitions.

| | | Penetration* | Penetration* | Penetration* in | Penetration* |
|---|---|---|---|---|---|
| | Imidacloprid | in cauliflower | in bell pepper | vine leaves after | in tomato |
| | Concentration | leaves after 4 | leaves after 4 | 4 days (Müller- | leaves after |
| Formulation | (g/1) | days | days | Thurgau, field) | 4 days |
| Confidor | 0.2 | 1% | 6.7% | 7.8% | 35% |
| SL200 | | | | | |
| Standard | | | | | |
| Formulation | 0.2 | 81% | 45.6% | 39.5% | 73% |
| as per | | | | | |
| Example 2 | | | | | |

*Penetration after 4 days via amount which cannot be removed by washing or fraction which cannot be removed from the surface by the cellulose stripping technique (of Silcox and Holloway, 1986), and additionally autoradiography

### Silcox, D., Holloway, P. (1986), Aspects of Applied Biology 11, 13-16

### Use Example III

Imidacloprid applied by spraying to citrus fruits and stone fruits (0.05% by weight, 1000 l/ha) against Dysaphis plantaginea.

The table below contains average values from a number of field trials in Spain, comparing the formulation as per Example 2 (0.05% by weight concentration at 1000 l/ha) with the commercial formulation Confidor SL 200.

% Abbott=100*(infestation control−infestation treatment)/infestation control

Full infestation treatment=no action=0% Abbott

No infestation treatment=full action=100% Abbott

DAA=(days after application)

Abbott in %

| | 8 DAA | 17 DAA |
|---|---|---|
| Confidor SL 200 | 59 | 98 |
| Example 2 | 74 | 100 |

### Use Example IV

Penetration test as above

Spray liquor A

| | | |
|---|---|---|
| 0.1 | g | imidacloprid |
| 0.32 | g | sunflower oil |
| 0.05 | g | polyoxyethylene-sorbitol oleate |
| 0.025 | g | polyoxyalkyleneamine derivative |
| 0.01 | g | lignin sulphonate |
| | | in 1 litre of water. |

Spray liquor B

| | | |
|---|---|---|
| 0.1 | g | imidacloprid |
| 0.2 | g | alkanol alkoxylate from Preparation Example 1 |
| 0.05 | g | polyoxyethylene-sorbitol oleate |
| 0.025 | g | polyoxyalkyleneamine derivative |
| 0.01 | g | lignin sulphonate |
| | | in 1 litre of water. |

Spray liquor C

| | | |
|---|---|---|
| 0.1 | g | imidacloprid |
| 0.44 | g | sunflower oil |
| 0.1 | g | alkanol alkoxylate from Preparation Example 1 |
| 0.05 | g | polyoxyethylene-sorbitol oleate |
| 0.025 | g | polyoxyalkyleneamine derivative |
| 0.01 | g | lignin sulphonate |
| | | in 1 litre of water. |

Spray liquor D

| | | |
|---|---|---|
| 0.1 | g | imidacloprid |
| 0.03 | g | acrylic graft copolymer (Atlox 4913) |
| 0.01 | g | tristyrylphenol ethoxylate |
| 0.1 | g | glycerol |
| | | in 1 litre of water. |

The water used in each of the spray liquors was CIPAC water.

The results of the experiments are apparent from the table below. The figures reported are average values from 5 measurements.

TABLE II

| | Active substance | | |
|---|---|---|---|
| | concentration | Penetration/% | Penetration/% |
| Formulation | (g/l) | after 2 h | after 23 h |
| Spray liquor A | 0.1 | <1 | <3 |
| Spray liquor B | 0.1 | 20.1 | 35.5 |
| Spray liquor C | 0.1 | 47.1 | 52 |
| Spray liquor D | 0.1 | <1 | <1 |

1. An oil-based suspension concentrate comprising
(a) at least one insecticide from the class of the neonicotinoids,
(b) at least one penetrant from the class of the alcohol ethoxylates of the formula (I)
R—O-(EO)ₘ—R′ (I)
in which
R is branched or unbranched C₈-C₁₅-alkyl,
m is 5, 6, 7, 8, 9, 10, 11, 12, 13, 14 or 15,
R′ is hydrogen or C₁-C₆-alkyl and
E is CH₂—CH₂,
(c) at least one vegetable oil, and
(d) at least one nonionic surfactant or dispersant, at least one anionic surfactant or dispersant or mixtures thereof.

2. A suspension concentrate according to claim 1, further comprising one or more additives selected from the group consisting of emulsifiers, foam inhibitors, preservatives, antioxidants, colorants, inert fillers and mixtures thereof.

3. A process for producing a suspension concentrate according to claim 1, comprising mixing
(a) at least one insecticide from the class of the neonicotinoids,
(b) at least one penetrant from the class of the alcohol ethoxylates of the formula (I)
R—O-(EO)ₘ—R′ (I)
in which
R is branched or unbranched C₈-C₁₅-alkyl,
m is 5, 6, 7, 8, 9, 10, 11, 12, 13, 14 or 15,
R′ is hydrogen or C₁-C₆-alkyl and
E is CH₂—CH₂,
(c) at least one vegetable oil, and
(d) at least one nonionic surfactant or dispersant, at least one anionic surfactant or dispersant or mixtures thereof,
and optionally grinding the resultant suspension.

4. A process for producing a suspension concentrate according to claim 2, comprising mixing
(a) at least one insecticide from the class of the neonicotinoids,
(b) at least one penetrant from the class of the alcohol ethoxylates of the formula (I)
R—O-(EO)ₘ—R′ (I)
in which
R is branched or unbranched C₈-C₁₅-alkyl,
m is 5, 6, 7, 8, 9, 10, 11, 12, 13, 14 or 15,
R′ is hydrogen or C₁-C₆-alkyl and
E is CH₂—CH₂,
(c) at least one vegetable oil,
(d) at least one nonionic surfactant or dispersant, at least one anionic surfactant or dispersant or mixtures thereof and
(e) one or more additives selected from the group consisting of emulsifiers, foam inhibitors, preservatives, antioxidants, colorants, inert fillers or mixtures thereof
and optionally grinding the resultant suspension.

5. A method of controlling insects, comprising applying to said insects or their habitats an insecticidally active amount of a suspension concentrate according to claim 1 in dilute or undiluted form.

6. A method of controlling harmful insects, comprising applying to said insects or their habitats an insecticidally active amount of a suspension concentrate according to claim 1.

7. A method of controlling insects, comprising applying to said insects or their habitats an insecticidally active amount of a suspension concentrate according to claim 2 in dilute or undiluted form.

8. A method of controlling harmful insects, comprising applying to said insects or their habitats an insecticidally active amount of a suspension concentrate according to claim 2 in dilute or undiluted form.
